(19) United States
(12) Patent Application Publication
(10) Pub. No.: US 2023/0264236 A1
(43) Pub. Date: Aug. 24, 2023

(54) VERTICAL PIPE CLEANING SYSTEM AND METHOD

(71) Applicant: Sandborn Roofs Inc., Nisku (CA)

(72) Inventors: Elias Lopez, Nisku (CA); Dave Vallee, Nisku (CA); Wes Glassford, Nisku (CA)

(21) Appl. No.: 18/083,099

(22) Filed: Dec. 16, 2022

Related U.S. Application Data
(60) Provisional application No. 63/311,708, filed on Feb. 18, 2022.

(51) Int. Cl. B08B 9/043; F16L 55/30; F16L 55/40

(52) U.S. Cl. CPC B08B 9/0436; F16L 55/30; F16L 55/40; B08B 2209/04; F16L 2101/12

(57) ABSTRACT

A cleaning device for cleaning vertical pipes includes a cylindrical section, a bottom plate and an upper plate having a cable attachment means, an internal weight, and at least one wiper disk, the device defining a fluid flow path through or around the device.

### FIELD OF THE INVENTION

The present invention relates to a pipe cleaning system and method for use in vertical or substantially vertical pipes, such as gauge poles, stilling wells or any other vertical piping.

### BACKGROUND OF THE INVENTION

An external floating roof tank is a storage tank commonly used to store large quantities of petroleum products such as crude oil or condensate. The tank has an open-topped cylindrical steel shell and a roof that floats on the surface of the stored liquid. The roof rises and falls with the liquid level in the tank. As opposed to a fixed roof tank there is no vapor space in the floating roof tank, except where liquid level falls to a very low level. There is a rim seal system between the tank shell and roof to reduce rim evaporation.

The tank includes instrumentation piping which conventionally runs vertically through the tank. This piping may build up internal residue over time, which may affect the accuracy of the monitoring instrumentation. Thus, it is desirable or required to periodically remove or reduce internal residue or obstructions in these vertical pipes.

### SUMMARY OF THE INVENTION

In summary, embodiments of the present invention provides systems and methods for cleaning vertical or substantially vertical pipes.

In one aspect, the invention comprises a cleaning device, comprising at least one cylindrical section, a bottom plate and an upper plate having a cable attachment means, an internal weight, and at least one wiper disk, the device defining a fluid flow path through or around the device.

In some embodiments, the device comprises one or more of the following features:

(a) a plurality of stacked cylindrical sections, joined by attachment flanges;

(b) a plurality of wiper disks, disposed between attachment flanges of adjacent stacked cylindrical sections, at least one of which is flexibly resilient;

(c) the internal weight comprises at least one cylindrical weight, positioned concentrically within the at least one cylindrical section, and preferably two or more cylindrical weights, concentrically disposed within the cylindrical section or sections, and each other.

In another aspect, the invention may comprise a kit for cleaning a substantially vertical pipe, comprising:

(a) a cleaning device having a first circular wiper disk and/or a first internal weight;

(b) at least one additional weight for adding to the cleaning device; and/or

(c) at least one additional circular wiper disk having a different diameter than the first circular wiper disk.

In some embodiments, the first internal weight and each additional weight is cylindrical, sized to concentrically nest within the cleaning device and each other.

In another aspect, the invention may comprise a method of cleaning a substantially vertical pipe using the devices claimed or described herein.

### BRIEF DESCRIPTION OF THE DRAWINGS

In the drawings, like elements may be assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention.

FIG. 1 shows the use of a cleaning device in a vertical pipe.

FIG. 2A shows a partial cutaway and partial cross-section of a cleaning device. FIG. 2B shows an exploded side elevational view of the same device. FIG. 2C shows an exploded perspective view of the same device, with a partial cutaway.

### DETAILED DESCRIPTION OF EMBODIMENTS OF THE INVENTION

The invention relates to an cleaning device and method for cleaning a vertical pipe, such as an instrumentation pipe in an oil storage tank.

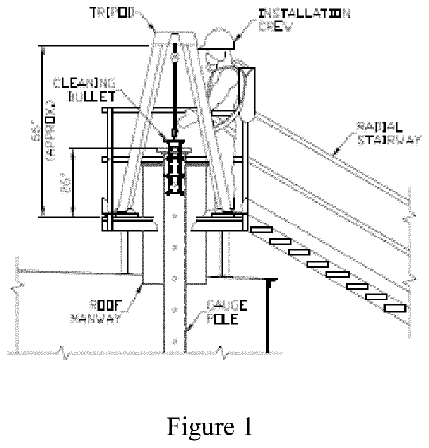

FIG. 1 shows a cleaning device 10 in position within the top portion of a vertical pipe, positioned within a roof manway of an oil storage tank. It is suspended from a tripod stand, a boom arm or the like, to be lowered into the vertical pipe. The pipe to be cleaned need not be precisely vertical. The device is gravity-fed into the pipe, therefore, the pipe needs only be sufficiently vertical to allow for gravity to lower the device into the pipe.

In a basic form, one embodiment of a cleaning device comprises at least one cylindrical section 12, a bottom plate 14 and an upper plate 16 having a cable attachment means 18, an internal weight 20, and at least one wiper disk 30, which preferably is a flexibly resilient disk. In a preferred embodiment, the device comprises a plurality of stacked cylindrical sections 12, joined by attachment flanges 13 and bolts. A plurality of wiper disks 30 are disposed between attachment flanges 13 of adjacent stacked cylindrical sections 12.

In some embodiments, the cleaning device defines at least one fluid flow path through its length, to allow gases and liquids to pass through, thereby allowing the device to pass through fluids within the pipe to be cleaned. Thus, both the bottom and top plates 14, 16 may be perforated and the cylindrical sections 12 and internal weights 20 have an internal bore. Alternatively or additionally, external flow paths may be provided by forming grooves or openings in exterior surfaces of the device 10 and/or disks 30.

The wiper disk 30 may comprise a rubber or elastomer ring, such as polyurethane, and is configured to clean the inside of the pipe by a wiping action. The wiper disk 30 may be relatively hard to promote a scraping action, or may be relatively soft to deform within the pipe and promote a wiping action. In some embodiments, a scraping edge may be included (not shown), that may be formed from a metal attachment or embedded member. Alternatively, the wiper disk 20 may include cleaning bristles or a textured surface.

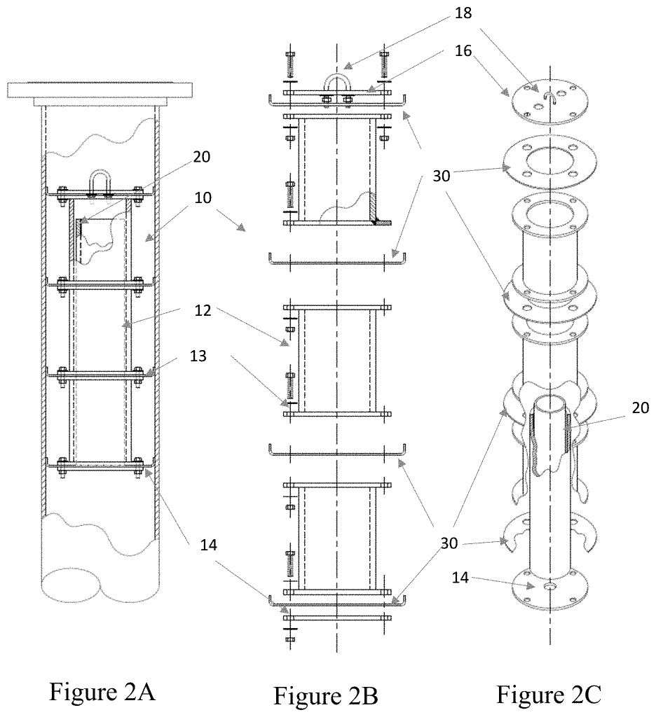

The wiper disks 30 are sized to clean the interior surface of the pipe as the cleaning device is lowered into the vertical pipe. If the wiper disk is formed from a softer, flexible material, the disk may be sized such that the outer edge of the disk 30 folds over to form a lip, as shown in FIG. 2B. In some embodiments, the wiper disks may be differently sized. For example, the lowermost disk may be smaller than the inside diameter of the pipe, and each upper disk may be slightly larger. In some embodiments, a first pass of the cleaning device may be made, followed by subsequent passes where the disks have been replaced with larger disks.

In some embodiments, the internal weight 20 comprises one or more cylindrical weights, concentrically nested within the at least one cylindrical section and each other.

The cleaning device is passed downwards by gravity through the pipe to be cleaned. If additional force is required, additional internal weights may be added by unbolting a section of the device (between sections or by removing either the top or bottom plate) and inserting as many cylindrical (hollow or solid) weights as required. The device may be made heavier by adding cylindrical sections to make the device longer.

A cleaning method may commence with a visual inspection of the pipe, such as a standard gauge pole, using an intrinsically safe camera. If the visual inspection produces evidence of scale or rust, or other material which can be cleaned, the cleaning device may be setup to be lowered into the gauge pole using a tripod or other stand. A first pass may be made with a smaller size of wiping disks, followed by a successive pass with at least one larger disk. If the cleaning device is obstructed by materials to be cleaned out, the device may be cycled up and down in an effort to break up the obstructing materials, or alternatively, a smaller wiping disk may be used. Multiple cleaning cycles may be made until the pipe is considered to be satisfactorily cleaned.

Interpretation.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

1. A cleaning device, comprising at least one cylindrical section, a bottom plate and an upper plate having a cable attachment means, an internal weight, and at least one wiper disk, the device defining a fluid flow path through or around the device.

2. The device of claim 1 comprising:
(a) a plurality of stacked cylindrical sections, joined by attachment flanges; and
(b) a plurality of wiper disks, disposed between attachment flanges of adjacent stacked cylindrical sections.

3. The device of claim 1 wherein the internal weight comprises two or more cylindrical weights, concentrically disposed within the at least one cylindrical section and each other.

4. The device of claim 1 wherein the at least one wiper disk comprises a flexibly resilient material.

5. The device of claim 1 comprising at least two wiper disks, which have the same or different diameter.

6. A kit for cleaning a substantially vertical pipe, comprising:
(a) a cleaning device having a first circular wiper disk; and
(b) at least one additional circular wiper disk having a different diameter than the first circular wiper disk.

7. The kit of claim 6 wherein the cleaning device further includes a first internal weight, the kit comprising at least one additional weight for adding weight to the cleaning device.

8. The kit of claim 6 wherein the cleaning device comprises a plurality of wiper disks, and the at least one additional circular wiper disk comprises a plurality of additional wiper disks having at least two different sizes.

9. The kit of claim 7 wherein the first internal weight and the at least one additional weight is cylindrical, sized to concentrically nest within the cleaning device and/or each other.
